(19) United States
(12) Patent Application Publication
(10) Pub. No.: US 2018/0202522 A1
(43) Pub. Date: Jul. 19, 2018

(54) VIBRATORY SYSTEM HAVING AN OSCILLATING PLATE

(71) Applicants: UNIVERSITÉ DE BORDEAUX, Bordeaux (FR); INSTITUT POLYTECHNIQUE DE BORDEAUX, Talence Cedex (FR); CENTRE NATIONAL DE LA RECHERCHE SCIENTIFIQUE, Paris (FR)

(72) Inventor: Jérémy JALLAGEAS, Biscarosse (FR)

(21) Appl. No.: 15/743,656

(22) PCT Filed: Jul. 7, 2016
(86) PCT No.: PCT/EP2016/066119

§ 371 Date: Jan. 10, 2018

(30) Foreign Application Priority Data
Jul. 10, 2015 (FR) 1556620

(51) Int. Cl. F16H 25/16; B23B 39/10

(52) U.S. Cl. CPC F16H 25/16; B23B 39/10

(57) ABSTRACT

Some embodiments are directed to an oscillating system including at least one drive motor for driving a spindle about an axis of rotation, a first plate cooperating with a second plate, wherein the first plate is inclined with respect to the axis of rotation, in that the second plate is ball-jointed on a second axis that is offset with respect to the axis of rotation, creating an amplitude of oscillations in the spindle, in that at least one of the two plates is driven by the drive motor, and in that the two plates rotate at different speeds. The combination of the inclination of the first plate and the eccentricity of the center of rotation of the second plate makes it possible to create an oscillation in the spindle while it rotates.

### CROSS REFERENCE TO RELATED APPLICATIONS

This application is a national phase filing under 35 C.F.R. § 371 of and claims priority to PCT Patent Application No. PCT/EP2016/066119, filed on Jul. 7, 2016, which claims the priority benefit under 35 U.S.C. § 119 of European Patent Application No. 1556620, filed on Jul. 10, 2015, the contents of each of which are hereby incorporated in their entireties by reference.

### BACKGROUND

Some embodiments relate to kinematics, which make it possible to create an alternating axial or to-and-fro or vibratory movement.

The technique of vibratory drilling was proposed in the 1950s. The principle of the technique includes adding an axial oscillatory movement, also known as a vibratory movement, to the cutting movement of the tool. The oscillating or vibratory movement is defined by two parameters, i.e. the amplitude and frequency of the oscillations.

Habitually applied to machining operations which are carried out with continuous cutting (including perforation, drilling, boring, turning, screw cutting, etc.), this technique makes it possible to vary the stepover of the tool cyclically. The stepover is the parameter of the process which makes it possible to regulate the thickness of the sliver.

During machining with continuous cutting, the cross-section of the sliver remains constant over a period of time. On the other hand, during vibratory drilling, the thickness of the sliver at the instant t₁ will differ from that at the instant t₂. In addition, it is found that this thickness may be cancelled out intermittently, causing the interruption of the formation of the strip of sliver. The sliver will then no longer be continuous but “fragmented”.

The distinction between the technique of vibratory drilling and that which uses sliver-breaking cycles (for example de-coring cycles) consists in the frequency of the axial to-and-fro movement: in the case of sliver-breaking cycles, this frequency will be systematically greater than the frequency of rotation of the tool. The sliver will therefore not have a fragmented morphology, but rather will be short, or also of medium length.

Drilling in vibratory mode is used in deep perforation or drilling operations, in order to limit the risks of jamming of slivers in the flutes of the tool. As well as improving the discharge of the slivers, other more recent uses utilize the vibratory technique to reduce the heating of the tool.

The existence of vibratory drilling devices is known from publications FR 2 907 695, DE 10 2005 002 462, FR 2 902 848 and WO 2011/061 678, which are integrated by reference. The mechanical systems proposed use the technology of cams in different manners.

In application FR 2 907 695, the oscillations are generated by cams without rolling units. This results in friction on the cam which gives rise to heating and noise. In addition, the optimum vibratory frequency for the correct fragmentation of the sliver is not always obtained because this frequency is a whole multiple of the speed of rotation of the advance pinion relative to the spindle or relative to the frame.

In patent DE 10 2005 002 462, a spring exerts a return force on a bearing including an undulating surface, in a direction of advance of the drill, in order to provide axial vibrations. In the event of high axial pressure of the drill, the rolling units can cease to roll on the undulating surface, and the drill stops oscillating. In order to prevent this disadvantage, the spring must or should have substantial rigidity, which can result in the bearing being oversized. This can lead to a substantial cost.

Finally, patent WO 2011/061678 discloses an improved technical solution compared with the systems previously cited. Firstly, the proposed vibratory system has rolling units which make it possible to limit the friction. The number of vibratory periods per revolution of the spindle is a rational or a number which is not whole, defined by the geometry of the cam, and constant during the period. The advantage of a non-whole number makes it possible to avoid a parallel trajectory of the cutting ridges during the drilling, and increases the efficiency of fragmentation of the slivers.

### SUMMARY

However, the use of the vibratory technology using a cam does not make it possible to obtain an optimum oscillatory movement. In fact, the possibilities of regulation of the frequency and the amplitude are limited by the form of the cam and by the precision of its machining. In particular, this involves the use of a high amplitude during drilling with a small advance, and thus gives rise to substantial mechanical stress of the machining system. In addition, the costs which are associated with the machining, then with the wear and the breakage of the cams, are significant.

For example, in the case of drilling of multiple materials, which is frequently encountered in the aeronautical industry, drilling of materials with different machining properties needs to be carried out. It is then necessary to be able to regulate the vibratory parameters (frequency, amplitude of the oscillations).

For reasons of accessibility, aeronautical drilling is frequently carried out by use of portable drilling units. The vibratory technology must or should therefore be able to be incorporated in these compact drilling systems.

A drilling unit is a device for control of the tool. Application FR 2 881 366 describes a drilling device including two gear trains, and is integrated by reference. The first train consists of a drive pinion and a spindle pinion. It makes it possible to impart movement of rotation to the spindle by use of a slide connection. The second train consists of an interlocking pinion and an advance pinion. The latter is in helical connection with the spindle.

During the drilling phase, the interlocking pinion is coupled with the drive pinion which rotates it. Once it is in motion, the interlocking pinion will rotate the advance pinion. The speed differential of the spindle pinions and advance pinion will create the movement of advance of the spindle. When the phase of rising of the spindle begins, the interlocking pinion separates from the drive pinion, in order to be inserted in the frame of the drilling device. The interlocking and advance pinions thus stop rotating. By use of the fixed helical connection, the spindle, by continuing to rotate, will be displaced in the opposite direction, and therefore rise.

WO2014125182 proposes alternative kinematics to the preceding ones, by offsetting the interlocking pinion and the drive pinion. Because the two pinions are offset, the distance between a point J belonging to the interlocking pinion and the center of rotation of the drive pinion will develop constantly. This means that the angular position of the interlocking pinion will oscillate relative to that of the drive pinion. The fluctuation of the speed at the interlocking pinion will then be translated to the spindle by a movement of oscillation.

Some embodiments are directed to an oscillating system, which combines all or most the qualities of the related vibratory systems, i.e., an extensive selection of regulations, a non-whole number of oscillations per revolution, robustness, low wear, and a reduced size of the system, etc.

The oscillating system according to some embodiments includes a spindle, at least one drive motor to drive the spindle about an axis of rotation, a first plate and a second plate, the first plate cooperating with a second plate. The first plate is inclined relative to the axis of rotation, the second plate is ball-jointed on a second axis which is offset relative to the axis of rotation, thus creating an amplitude of oscillations in the spindle, in that at least one of the two plates is driven by the drive motor, and in that the two plates rotate at different speeds. The combination of the inclination of the first plate and the eccentricity of the center of rotation of the second plate, and the difference of speed between the two plates, makes it possible to create oscillation of the spindle during its rotation. By use of the ball-jointed connection of the second plate, the two plates can remain parallel. Preferably, the first plate is fixed to the spindle. The second plate rotates at a speed different than the first plate, or even in the inverse direction.

Advantageously, the two plates are in contact by use of balls. The use of balls makes it possible to maintain regular contact between the two plates and to limit the friction. The balls can be arranged on the first or on the second plate.

Advantageously, the amplitude of the oscillations is adjustable. By adjusting the different parameters of inclination and eccentricity of one or both plates, it is possible to vary the amplitude of the oscillations of the spindle.

According to a first arrangement, the inclination of the first plate is adjustable. For example, this plate can be connected to the axis of rotation by a connection of a finger ball-joint type, in order to block its rotation about the axis of the spindle. The plate can be inclined by use of an endless screw which cooperates with the first plate. The regulation device can for example be fixed to the first plate, and rotate together with it.

According to a second arrangement, the offsetting of the second axis relative to the axis of rotation is adjustable. For example, the eccentricity of the second plate relative to the first plate can be modified for example by changing the ball-jointed support in which the second plate is placed.

Advantageously, the number of oscillations per rotation is adjustable. By adjusting the difference of speed between the two plates 2 and 3, it is possible to vary the frequency of oscillations of the spindle.

According to a first variant, the plates are driven by different motors. It will thus be possible to make them rotate at different speeds, or even in the inverse direction.

According to a second variant, the plates are driven by a gear train. This can be an epicyclic train.

### BRIEF DESCRIPTION OF THE FIGURES

Other advantages will also be able to become apparent to one of ordinary skill in the art from reading the following examples, illustrated by the appended figures, and given by way of example:

FIG. 1 represents a schematic view of the vibratory system according to some embodiments;

FIG. 2 is a view in perspective of the vibratory system;

FIG. 3 is a view in cross-section of FIG. 3.

### DETAILED DESCRIPTION OF EXEMPLARY EMBODIMENTS

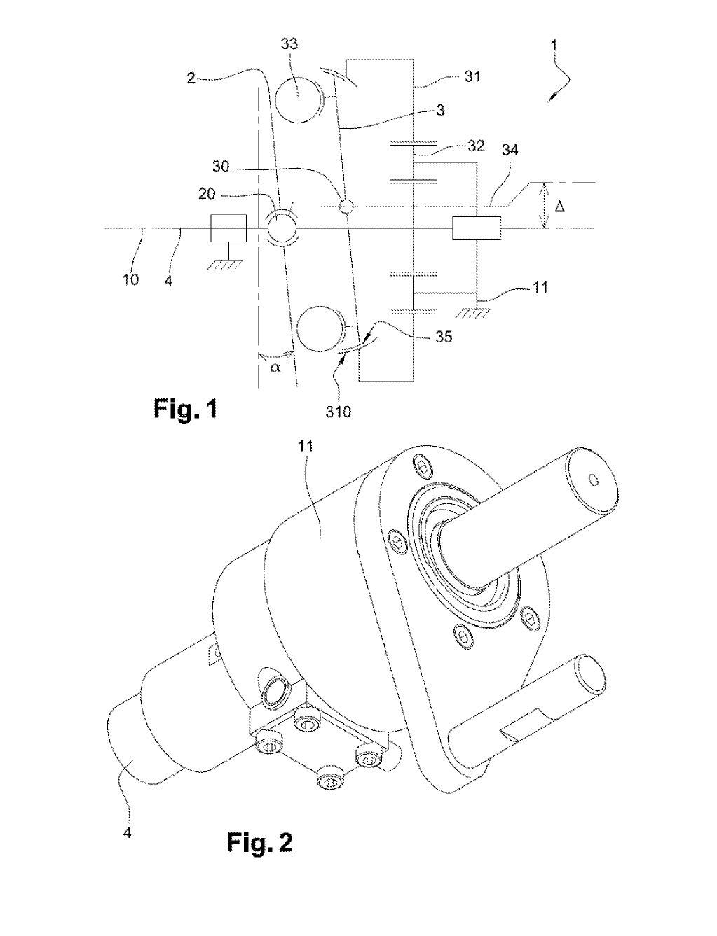

The diagram of the system 1 according to some embodiments illustrated in FIG. 1 includes:
a first plate 2 placed on an axis of rotation 10 by use of a finger ball-joint connection 20;
a spindle 4 secured on the axis 10;
a second plate 3, which is placed opposite the first plate 2, and is ball-jointed around a center of rotation 30 in a ball joint support 31. The second plate 3 preferably has rounded edges 35 which slide freely in a rounded rim 310 of the ball-joint support 31.

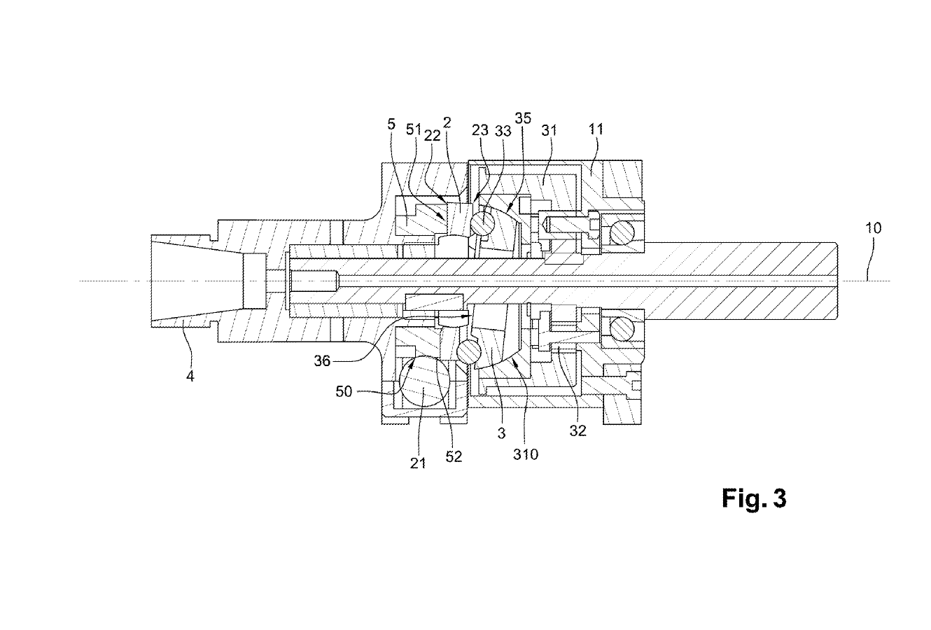

The ball joint support 31 rotates around the axis 10, and in this case is driven by the ring of the epicyclic train 32. FIG. 3 shows that the satellite-holder 11 of the epicyclic train is fixed. The speed ratio between the input planetary gear and the output ring is equal to −0.5 in the present case.

The second plate 3 includes balls 33 which constitute a bearing, and remain in contact with the first plate 2.

The center of rotation 30 is placed on an axis 34 which is offset relative to the axis of rotation 10 by a distance Δ.

The first plate 2 has inclination α which can be regulated by an endless screw 21 which cooperates with teeth 50 arranged on a peripheral edge 52 of a regulation wheel 5. The latter has one of its two faces 51 inclined relative to the axis 10, and forms a maximum angle equal to half of α. The plate 2 has two faces 22 and 23 which form between one another a maximum angle equal to half of α. The finger ball-joint connection of the plate 2 to the axis 10 makes it possible to keep the two inclined faces 22, 51 parallel. Thus, the face 23 is itself inclined relative to the axis 10 by an angle equal to α, which depends on the two inclinations and on the angular position of the wheel 5 relative to the plate 2, which can be up to a maximum of α.

A description will now be provided of the operation of the vibratory system.

The spindle 4 is rotated by a drive motor (not represented) of the machine in which the vibratory system 1 is integrated. By rotating the regulation wheel 5 by use of the endless screw 21, it is possible to arrange the two inclined slopes 51, 22 staggered or with opposite inclinations. Thus, the face 23 of the plate 2 becomes perpendicular to the axis 10 (α=0). Apart from this staggered arrangement of 51 and 22, the angle α is non-zero. It is thus possible to regulate the inclination of the first plate 2, and maintain said the plate 2 in position. During operation, the first oscillating plate 2 is considered in complete connection with the spindle 4. The first plate 2 will then impart axial vibration to the spindle 4.

The second plate 3 includes balls 33 accommodated on its face 36 opposite the first plate 2, in order to transmit forces to the frame and to ensure that the oscillating plate 2 has a flat support, regardless of the inclination of the plate. The second plate 3 is accommodated in the ball-jointed support 31. In this configuration, the ball-jointed support 31 is in pivot connection with the satellite holder 11 or with a frame 11.

The advantage of this design is to have offset the center of ball-jointing of the second plate 3. Because of this offsetting, the axial position of the center of the ball joint 30 will be sensitive to the inclination of the oscillating plate 2. The resulting amplitude of the vibrations is provided by the following equation:

Amp_{vib} (mm)=2·Δ·tan(α)

The amplitude of the oscillations can be adjusted by changing the inclination of the oscillating plate 2 or the value of the offsetting of the second plate 3.

The frequency of vibration is derived from the speed differential between the oscillating plate 2 and the second plate 3. When the latter is fixed relative to the frame 11, the number of oscillations per revolution of spindle is equal to 1. By use of the intervention of an epicyclic train, the second plate 3 can rotate at a speed different than that of the spindle 4. It is thus possible to modulate the frequency of the oscillations, or even to cancel them out. The number of oscillations per rotation is provided by the following equation:

$${Fq}_{vib} ( oscillations \text{/} revolution ) = \frac{\vert {Fq}_{rotations of spindle} - {Fq}_{rotations of stop support} \vert}{{Fq}_{rotations of spindle}}$$

A return spring (not represented) can be added to the system in order to maintain the contact between the different units in the absence of force on the spindle.

This system has the following advantages: simplicity of the vibratory system, reduced dimensions, and the possibility of modulating the amplitudes and frequency of the oscillations, without dismantling the system.

1. An oscillating system, comprising:
a spindle;
at least one drive motor configured to drive the spindle about an axis of rotation;
a first plate and a second plate, the first plate cooperating with the second plate, the first plate being inclined relative to the axis of rotation, the second plate being ball-jointed on a second axis, which is offset relative to the axis of rotation, thus creating an amplitude of oscillations in the spindle, such that at least one of the two plates are driven by the drive motor, and the two plates rotate at different speeds.

2. The oscillating system as claimed in claim 1, wherein the two plates are in contact by balls.

3. The oscillating system as claimed in claim 1, wherein the amplitude of the oscillations is adjustable.

4. The oscillating system as claimed in claim 1, wherein the inclination of the first plate is adjustable.

5. The oscillating system as claimed in claim 3, wherein the offsetting of the second axis relative to the axis of rotation is adjustable.

6. The oscillating system as claimed in claim 1, wherein the number of oscillations per rotation is adjustable.

7. The oscillating system as claimed in claim 1, wherein the plates are driven by different motors.

8. The oscillating system as claimed in claim 6, wherein the plates are driven by a gear train.

9. The oscillating system as claimed in claim 2, wherein the amplitude of the oscillations is adjustable.

10. The oscillating system as claimed in claim 2, wherein the inclination of the first plate is adjustable.

11. The oscillating system as claimed in claim 3, wherein the inclination of the first plate is adjustable.

12. The oscillating system as claimed in claim 4, wherein the offsetting of the second axis relative to the axis of rotation is adjustable.

13. The oscillating system as claimed in claim 2, wherein the number of oscillations per rotation is adjustable.

14. The oscillating system as claimed in claim 3, wherein the number of oscillations per rotation is adjustable.

15. The oscillating system as claimed in claim 4, wherein the number of oscillations per rotation is adjustable.

16. The oscillating system as claimed in claim 5, wherein the number of oscillations per rotation is adjustable.

17. The oscillating system as claimed in claim 2, wherein the plates are driven by different motors.

18. The oscillating system as claimed in claim 3, wherein the plates are driven by different motors.

19. The oscillating system as claimed in claim 4, wherein the plates are driven by different motors.

20. The oscillating system as claimed in claim 5, wherein the plates are driven by different motors.
